(19) United States
(12) Patent Application Publication
(10) Pub. No.: US 2010/0009728 A1
(43) Pub. Date: Jan. 14, 2010

(54) PORTABLE TERMINAL

(75) Inventors: Masashi Koshi, Ishikawa-shi (JP); Hideo Nakanisi, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/445,449

(22) PCT Filed: Oct. 13, 2006
(86) PCT No.: PCT/JP2006/320498

§ 371 Date: Apr. 13, 2009

(51) Int. Cl. H04M 1/02; H01Q 1/24

(52) U.S. Cl. 455/575.3; 343/702

(57) ABSTRACT

To provide a portable terminal that exhibits high antenna performance and that enables structural simplification.

A portable terminal 10 can select a first state in which an upper housing 11 and a lower housing 12 are piled one on top of the other or a second state in which the upper housing 11 and the lower housing 12 are separated from each other, by relatively moving the upper housing 11 and the lower housing 12 through a joint section 13. The portable terminal 10 has a third housing 25 that is joined to the lower housing 12 and that houses an antenna element 26. When a second state is selected, the upper housing 11 contacts the third housing 25, whereby the third housing 25 can move in a direction away from the upper housing 11.

### TECHNICAL FIELD

The present invention relates to a portable terminal having an antenna connected to a communication section and that allows selection between a portable state (a first state) and an extended state (a second state) by moving a first housing and a second housing.

### BACKGROUND ART

A portable terminal serving as a portable flip radio is made up of an upper housing equipped with a receiver section and an LCD and a lower housing equipped with a transmitter section and operation keys, and can assume both configurations; namely, an extended state (a first state) in which the upper housing and the lower housing are opened and a portable state (a second state) in which the upper housing and the lower housing are closed.

In this portable terminal, it is preferable to separate an antenna from a human body in a call state and not to cover the antenna with a hand during operation of keys. For these reasons, an optimum position where an antenna section is placed is a hinge-side extremity of the lower housing.

However, when the antenna section is placed at the hinge, the upper housing comes close to the antenna section in an extended state, which may degrade the performance of the antenna for reasons of electromagnetic coupling between the antenna and the upper housing.

A portable terminal configured so as to enable turning of an antenna in synchronism with operation for changing the upper housing and the lower housing from a portable state to an extended state has hitherto been known as a countermeasure against degradation in antenna performance.

When the portable terminal is brought into an extended state (a call state) in which an upper housing and a lower housing are opened, an angle of the antenna is changed, so that the antenna is separated from the upper housing and that electromagnetic coupling with the upper housing is reduced. Thus, high antenna performance can be assured.

In the meantime, when the portable terminal is brought into a portable state in which the upper housing and the lower housing are closed, the antenna is held in the thickness of the portable terminal, thereby preventing an increase in thickness of the antenna section (for instance, Patent Document 1).

Patent Document 1: JP-A-2003-318767

### DISCLOSURE OF THE INVENTION

### Problem that the Invention is to Solve

However, in order to separate the antenna from the upper housing when the upper housing and the lower housing are brought into an extended state and to hold the antenna in the thickness of the portable terminal when the portable terminal is brought into a portable state, the portable terminal of Patent Document 1 uses a plurality of gears, for instance, as means for moving the antenna. Therefore, the number of components increases, which in turn impedes simplification of the structure of the portable terminal.

The present invention has been conceived to solve the problem and aims at providing a portable terminal that exhibits high antenna performance and that enables structural simplification.

### Means for Solving the Problem

An aspect of a portable terminal of the present invention is a portable terminal comprising: a first housing; a second housing joined to the first housing through a joint section, a first state in which the first housing and the second housing are piled one on top of the other and a second state in which the first housing and the second housing are separated from each other being achieved by relatively moving the first housing and the second housing through the joint section; and a third housing that is joined to the second housing and that houses an antenna, wherein the first housing contacts the third housing in the second state, whereby the third housing moves in a direction away from the first housing.

When the portable terminal is in the second state, the first housing contacts the third housing, thereby moving the third housing in a direction away from the first housing.

The antenna housed in the third housing is separated from the circuit board housed in the first housing, whereby electromagnetic coupling is lessened, and mismatching is reduced. Thus, high antenna performance can be assured.

In addition, the portable terminal is configured such that, when the portable terminal is in the second state, the first housing is brought into contact with the third housing, thereby causing the first housing to move the third housing. Thus, the first housing is caused to double as means for moving the third housing, whereby the number of members newly prepared to move the third housing can be reduced, and the structure of the portable terminal can be simplified.

The present invention also has a feature that the third housing is turnably joined to the second housing.

In such a portable terminal, the third housing is turnable with respect to the second housing. Hence, the structure for moving the third housing can be simplified, and reliable operation is performed.

Further, the present invention also has a feature that the joint section has a first pin orthogonal to a direction in which the first housing and the second housing in the first state are piled one on top of the other; the third housing is joined to the second housing through a second pin; and the first pin and the second pin are parallel to each other.

The present invention also has a feature that the first pin and the second pin are arranged in line with each other.

In such a portable terminal, the first shaft and the second shaft are arranged in line with each other; hence, the overall thickness and dimension of the portable terminal achieved in the first state can be reduced.

Moreover, the present invention also has a feature in that the joint section has a first pin orthogonal to a direction in which the first housing and the second housing in the first state are piled one on top of the other; and that the third housing is joined to the second housing through the first pin.

In such a portable terminal, the third housing is joined to the second housing through the first pin orthogonal to the direction in which the first housing and the second housing are piled one on top of the other, and hence the second pin becomes obviated, thereby reducing the number of components.

The present invention has a feature the third housing is joined to the second housing so as to be slidable.

Even in such a portable terminal, the antenna housed in the third housing is separated from the circuit board housed in the first housing, thereby reducing electromagnetic coupling and mismatching. Thus, high antenna performance can be assured.

The present invention has a feature characterized by further comprising a connector for electrically connecting the second housing to the antenna, wherein the connector can follow movement of the third housing with respect to the second housing.

The connector is made able to follow movement of the third housing with respect to the second housing, whereby power feeding can be assured.

The present invention also has a feature that the connector has an elastic member that exhibits conductivity.

Since the connector has an elastic member exhibiting conductivity, a feeding state can be reliably assured.

The present invention also has a feature that the connector has a conductive rail provided on either the second housing or the third housing and a conductive rolling member that rolls over the conductive rail.

The present invention also has a feature characterized by further comprising a return spring that restores the third housing to its initial position in the first state with respect to the second housing.

There is provided a return spring for restoring the third housing to its initial position, so that the third housing can be reliably returned to the initial position when the portable terminal is in the first state.

Moreover, the third housing is reliably restored to its original position when the portable terminal is in the first state, whereby a design benefit, which would be achieved in the first state, is yielded, and superior portability is attained.

Further, an aspect of the present invention is characterized by a portable terminal comprising: a first housing; a second housing joined to the first housing through a joint section, a first state in which the first housing and the second housing are piled one on top of the other and a second state in which the first housing and the second housing are separated from each other being achieved by relatively moving the first housing and the second housing through the joint section; and a third housing that is joined to the second housing and that houses an antenna, wherein the third housing is movable with respect to the second housing and arranged so as to form a step with regard to an outwardly-facing back side of the second housing.

Deterioration of an antenna characteristic, which would otherwise be caused when the portable terminal is placed on a (metal) table, is conceivable.

Therefore, the third housing is placed so as to produce a step with respect to an outwardly-facing back side of the second housing.

When the portable terminal is placed on a table (made of metal) regardless of whether the portable terminal is in the first state or the second state, the antenna element is separated from the table, so that deterioration of the antenna characteristic can be reduced.

The present invention also has a feature characterized by a portable terminal comprising: a first housing; a second housing joined to the first housing through a joint section, a first state in which the first housing and the second housing are piled one on top of the other and a second state in which the first housing and the second housing are separated from each other being achieved by relatively moving the first housing and the second housing through the joint section; and a third housing that is joined to the second housing and that houses an antenna, wherein the third housing is movable with respect to the second housing, and a relative position of the third housing with regard to the second housing is restricted.

In order to assure an antenna characteristic, it is desirable to separate the third housing from the first housing. However, there is a value optimum for the dimension of separation between the third housing and the first housing.

Specifically, when the antenna element and the circuit board housed in the first housing are electromagnetically coupled together, a change arises in impedance, so that a mismatching loss increases.

When the antenna element and the circuit board of the first housing are electromagnetically coupled together, an antenna current is distributed over the first housing, which in turn results in an increase in antenna volume and an improvement in gain.

In the meantime, when the antenna element and the circuit board of the first housing are in too close proximity to each other, an increase in mismatching loss becomes dominant, which in turn deteriorates antenna gain.

When the antenna element and the circuit board of the first housing are too separated from each other, an improvement effect attributable to an increase in antenna volume is not yielded.

Therefore, it is preferable to fix the antenna at a distance at which an optimum balance between the changes is achieved.

Accordingly, a superior antenna characteristic is obtained by regulating the relative position of the third housing with respect to the second housing.

### ADVANTAGE OF THE INVENTION

When the portable terminal of the present invention selects the second state, the first housing contacts the third housing, thereby moving the third housing in a direction away from the first housing, thereby yielding an advantage of the ability to yield high antenna performance and achieve structural simplification.

### BRIEF DESCRIPTION OF THE DRAWINGS

FIG. 1 is an exploded perspective view showing a portable terminal (a first embodiment) of the present invention.

FIG. 2A is a front view showing a second state of a portable terminal of a first embodiment; FIG. 2B is a rear view showing a second state of the portable terminal of the first embodiment; and FIG. 2C is a side view showing the second state of the portable terminal of the first embodiment.

FIG. 3 is a principal-section enlarged view of the portable terminal of the first embodiment in the second state when viewed from the rear.

FIG. 4A is a cross-sectional view taken along line A-A shown in FIG. 3, and FIG. 4B is a cross-sectional view taken along line B-B shown in FIG. 3.

FIG. 5A is a front view showing a first state of the portable terminal of the first embodiment; FIG. 5B is a rearview showing the first state of the portable terminal of the first embodiment; and FIG. 5C is a side view showing the first state of the portable terminal of the first embodiment.

FIG. 6 is a principal-section enlarged view of the portable terminal of the first embodiment in the first state when viewed from the rear.

FIG. 7A is a cross-sectional view taken along line C-C shown in FIG. 6, and FIG. 7B is a cross-sectional view taken along line D-D shown in FIG. 6.

FIGS. 8A, 8B and 8C are views for explaining operation of an antenna section of the portable terminal of the first embodiment.

FIG. 9 is a principal-section enlarged view showing a second state of the portable terminal (a second embodiment) of the present invention.

FIG. 10A is a cross-sectional view taken along line E-E shown in FIG. 9 and FIG. 10B is a cross-sectional view taken along line F-F shown in FIG. 9.

FIG. 11A is a perspective view showing a first state of a portable terminal of a first modification, and FIG. 11B is a perspective view showing a second state of the portable terminal of the first modification.

FIG. 12A is a perspective view showing a first state of a portable terminal of a second modification, and FIG. 12B is a perspective view showing a second state of the portable terminal of the second modification.

FIG. 13 is a perspective view showing a first state of a portable terminal of a third modification.

FIG. 14A is a perspective view showing a first state of a portable terminal of a fourth modification, and FIG. 14B is a perspective view showing a second state of the portable terminal of the first modification.

FIG. 15A is a front view showing a second state of the portable terminal (the third embodiment) of the present invention, FIG. 15B is a rear view showing the second state of the portable terminal of the third embodiment, and FIG. 15C is a side view showing the second state of the portable terminal of the third embodiment.

FIG. 16 is a principal-section enlarged view of the portable terminal of the third embodiment in the second state when viewed from the rear.

FIG. 17 is a cross sectional view taken along line G-G shown in FIG. 16.

FIG. 18 is a principal-section enlarged view of the portable terminal of the third embodiment in the first state when viewed from the rear.

FIG. 19 is a cross-sectional view taken along line H-H shown in FIG. 18.

FIG. 20 is a principal-section enlarged view of a portable terminal (a fourth embodiment) of the present invention in the first state when viewed from the rear.

FIG. 21 is a cross-sectional view taken along line I-I shown in FIG. 20.

FIG. 22 is a principal-section enlarged view of the portable terminal (the fourth embodiment) of the present invention in the second state when viewed from the rear.

FIG. 23 is a cross-sectional view taken along line J-J shown in FIG. 22.

FIG. 24A is a perspective view showing a first state of a portable terminal of a fifth modification, and FIG. 24B is a perspective view showing a second state of the portable terminal of the fifth modification.

FIG. 25A is a perspective view showing a first state of a portable terminal of a sixth modification, and FIG. 25B is a perspective view showing a second state of the portable terminal of the sixth modification.

FIG. 26 is a perspective view showing a second state of a portable terminal of a seventh modification.

FIG. 27 is a perspective view showing a second state of a portable terminal of an eighth modification.

### DESCRIPTIONS OF THE REFERENCE NUMERALS

10, 40, 46, 47, 48, 49, 50, 70, 80, 82, 84, 86 PORTABLE TERMINAL
11 UPPER HOUSING (FIRST HOUSING)
12 LOWER HOUSING (SECOND HOUSING)
13, 47A, 48A, 49A, 82A, 84A, 86A JOINT SECTION
14, 44, 46A, 47B, 48B, 49B SECOND SHAFT
15, 51, 71 ANTENNA SECTION
19 UPPER CIRCUIT BOARD (CIRCUIT BOARD)
22 COMMUNICATION SECTION
25, 52 THIRD HOUSING
26, 53 ANTENNA ELEMENT (ANTENNA)
28, 42 FIRST AXIS
56, 72 CONNECTOR
57 RETURN SPRINT (ELASTIC MEMBER)
74 CONDUCTIVE RAIL
75 CONDUCTIVE ROLLER (CONDUCTIVE ROLLING MEMBER)

### BEST MODES FOR IMPLEMENTING THE INVENTION

### First Embodiment

Portable terminals of embodiments of the present invention will be hereinbelow described by reference to the drawings.

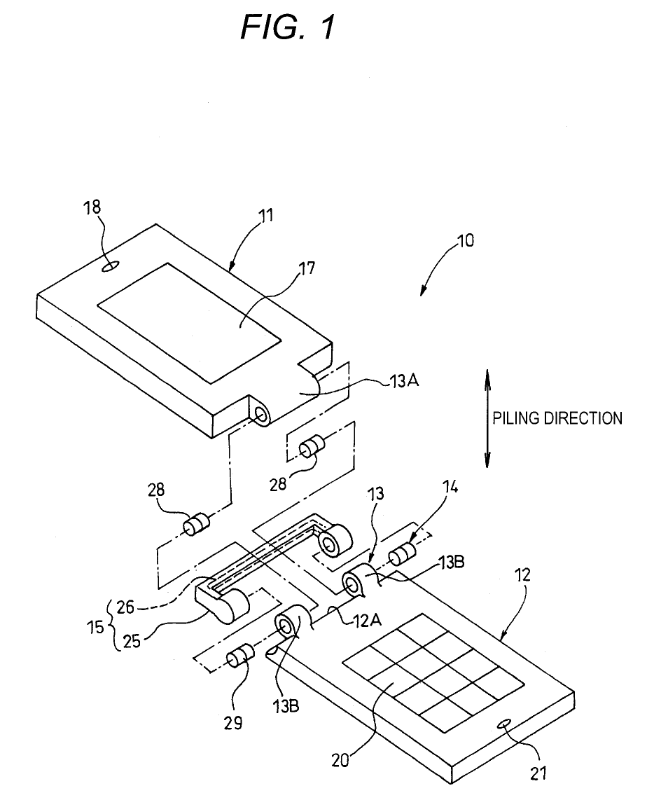

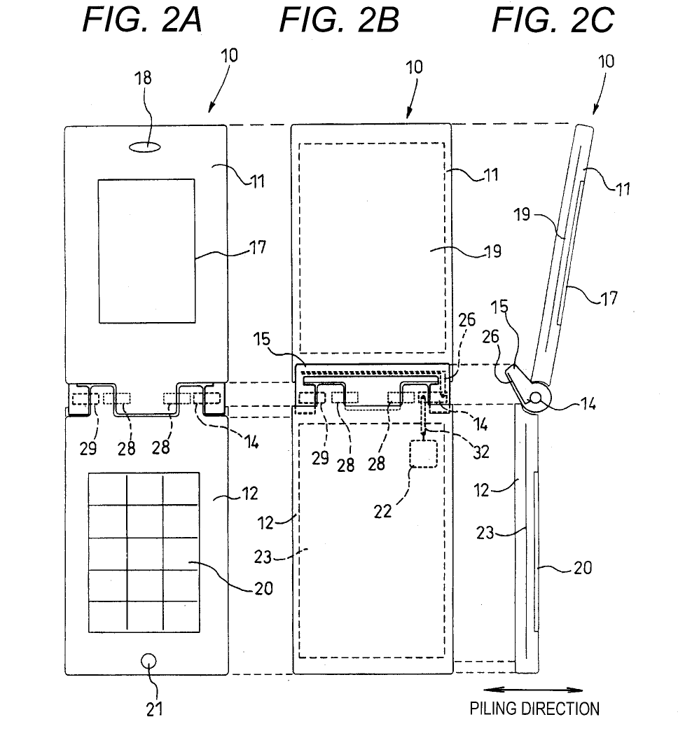

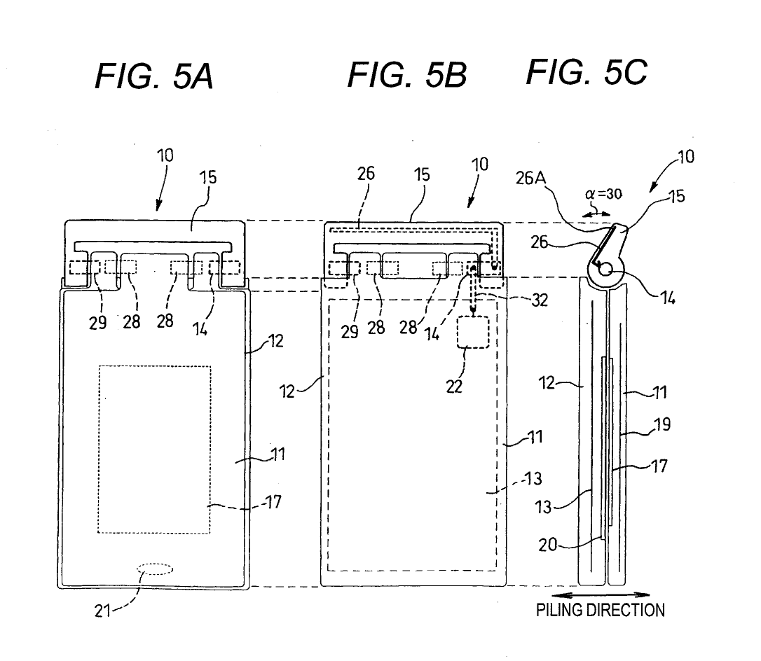

As shown in FIGS. 1 through 3, a portable terminal 10 of a first embodiment is a clamshell portable terminal that has an upper housing (a first housing) 11, a lower housing (a second housing) 12 turnably joined to the upper housing 11 through a joint section 13, and an antenna section 15 joined to the lower housing 12 through a second shaft (a second shaft for feeding power) 14; and that is configured so as to be able to select a first state (a portable state: see FIG. 5) in which the upper housing 11 remains folded over the lower housing 12 or a second state (an extended state: see FIG. 2) in which the upper housing 11 and the lower housing 12 are separated from each other, by relatively moving the upper housing 11 and the lower housing 12 through the joint section 13.

When the portable terminal 10 is used as a portable telephone, the portable terminal 10 is set in the second state (i.e., a call state).

A display section 17 and a receiver section 18 are provided on a surface of the upper housing 11, and an upper circuit board (a circuit board) 19 is housed in the upper housing.

An upper joint region 13A of the joint section 13 is made at a lower end of the upper housing 11.

An operation section 20 and a transmitter section 21 are provided on a surface of the lower housing 12, and a communication section (a matching circuit) 22 and a lower circuit substrate 23 are housed in the lower housing.

Lower joint regions 13B of the joint section 13 are formed at an upper end of the lower housing 12.

An antenna section 15 is joined to the lower housing 12 through a second pin 14. The antenna section 15 has a third housing 25 made of a resin, and an antenna element (antenna) 26 is housed in the third housing 25. The antenna element 26 is connected to the communication section 22 through the second pin 14.

The portable terminal 10 is configured such that the third housing 25 can move in a direction apart from the upper housing 11 as a result of the upper housing 11 contacting the third housing 25 when the upper housing 11 and the lower housing 12 are in the second state.

The joint section 13 has a pair of first pins 28 orthogonal to a piling direction in which the upper housing 11 and the lower housing 12 in the first state shown in FIG. 5 are piled one on top of the other.

The upper joint region 13A and the pair of lower joint regions 13B are turnably joined together by the pair of first pins 28.

The third housing 25 is turnably joined to the lower housing 12 through the second pin 14 and an auxiliary second pin 29.

The second pin 14, the auxiliary second pin 29, and the pair of first pins 28 are provided in parallel and in line with each other.

Specifically, the third housing 25 is joined to the pair of lower joint regions 13B formed on the lower housing 12 through the second pin 14 and the auxiliary second pin 29, and protrudes upward from an upper end 12A of the lower housing 12.

The auxiliary second pin 29 is arranged at a position that is horizontally symmetrical with respect to the second pin 14, and joins the antenna section 15 to the pair of lower joint regions 13B. The auxiliary second pin 29 is not connected to the communication section 22.

The third housing 25 is supported by the two second pins 14; namely, the second pin 14 and the auxiliary second pin 29, whereby the second pins 14 can be made small, and a characteristic superior to that achieved in the case of one second pin 14 can be properly held.

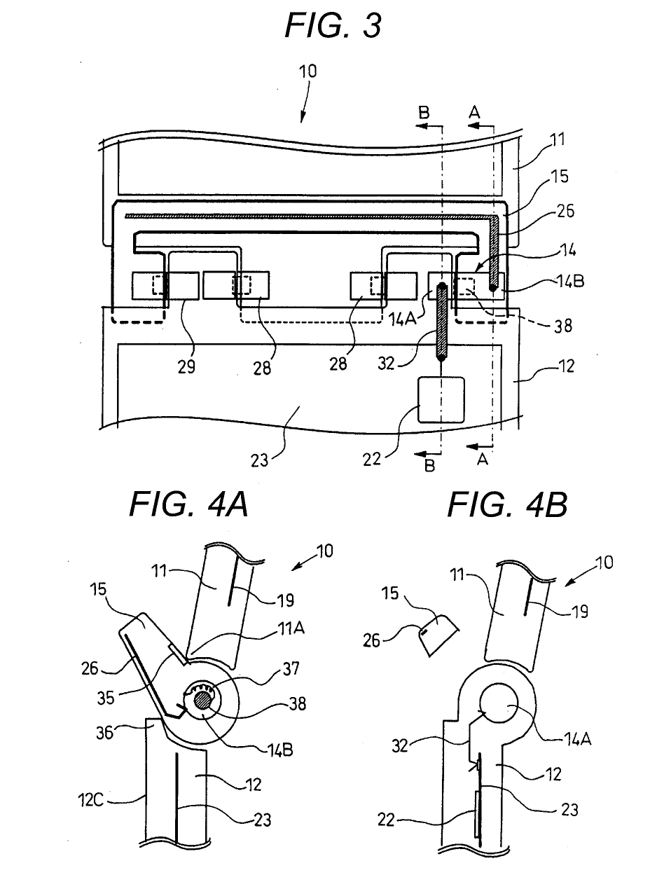

In the meantime, the second pin 14 is electrically connected to the communication section 22 by means of a feeding element 32. The feeding element 32 is connected to second pin metal piece 14A (see FIG. 3) that is a component making up the second pin 14.

The antenna element 26 is connected to second pin metal piece 14B (see FIG. 3) that is a component making up the second pin 14.

Therefore, the antenna element 26 and the communication section 22 are electrically connected together through the second pin 14. Further, the lower housing 12 (specifically, the pair of lower joint regions 13B) is made of, as an example, a resin; and hence the second pin 14 and the lower housing 12 are held in an electrically-unconnected state.

As shown in FIGS. 5A, 5B and 5C, in the first state of the portable terminal 10, the antenna section 15 protrudes upward from the upper housing 11 and the lower housing 12 and is inclined at an angle of 30 degrees, as an inclination angle α, toward the upper housing 12 with respect to the back side of the lower housing 12.

In this state, an extremity 26A of the antenna element 26 is located closer to the upper housing 11 than to the lower housing 12.

In the first state of the portable terminal 10, the antenna section 15 is housed in a thickness consisting of the upper housing 11 and the lower housing 12. Therefore, in the first state of the portable terminal 10, the antenna section 15 is prevented from protruding in a thicknesswise direction of the portable terminal 10.

As shown in FIGS. 4A, 4B, 7A and 7B, a spring member 37 is provided in the second pin 14 (specifically, the second pin metal piece 14B). The spring member 37 is connected to the second pin metal piece 14B and a rotary shaft 38.

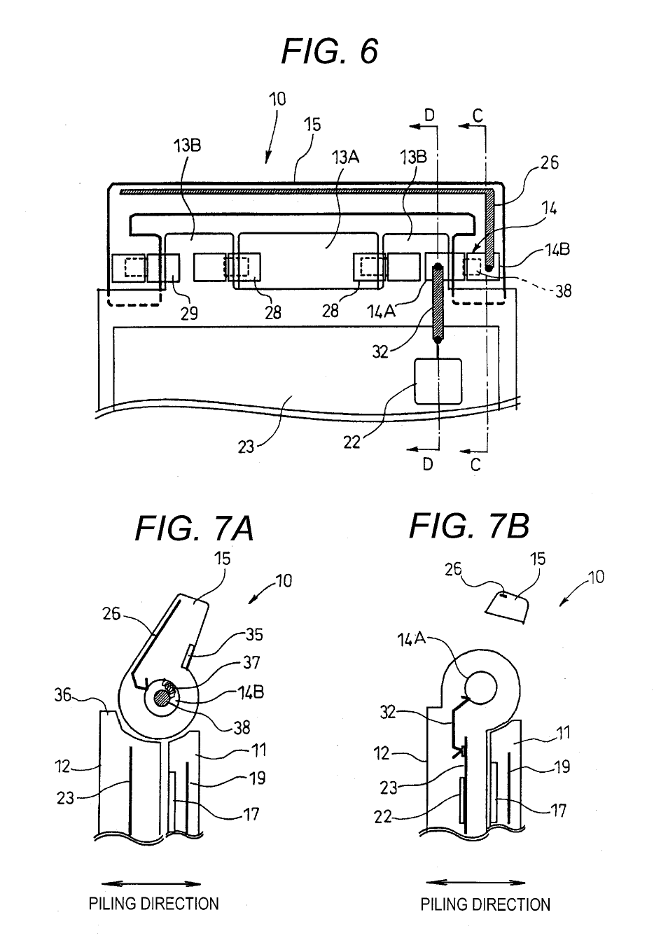

As shown in FIGS. 3 and 6, the rotary shaft 38 is fixed to the lower housing 12 through the second pin metal piece 14A and does not effect rotation even when the antenna section 15 is rotated.

Meanwhile, the second pin metal piece 14B is embedded in the antenna section 15 and rotated along with the antenna section 15.

As shown in FIG. 4A, even when the portable terminal is in the second state, a lower end angular section 11A of the upper housing 11 contacts a contact section 35 provided in the antenna section 15, and the antenna section 15 also contacts a stopper 36 provided on the lower housing 12.

In this state, the antenna section 15 protrudes outward in excess of the back side 12C of the lower housing 12, and the antenna section 15 is held apart from the upper housing 11. Therefore, the antenna section 15 can be held apart from the upper circuit board 19.

By separating the antenna element 26 from the upper circuit board 19, electromagnetic coupling between the antenna element and the upper circuit board is diminished, so that high antenna performance can be assured.

In addition, the position of the third housing 25 relative to the lower housing 12 is appropriately regulated by the stopper 36, whereby a much superior antenna characteristic can be obtained.

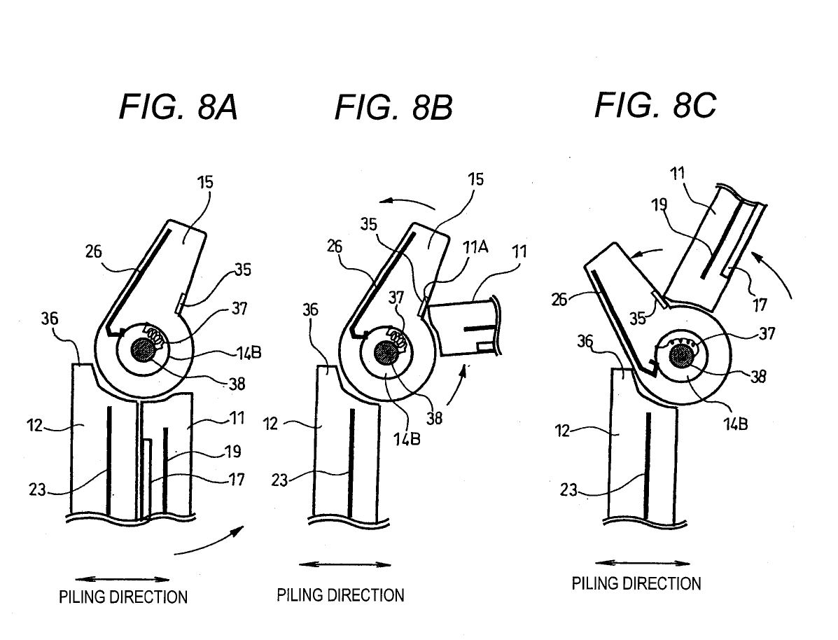

Next, operations of the antenna section 15 responsive to the opening and closing actions of the portable terminal 10 will be described by reference to FIGS. 8A to 8C.

First, an example achieved in a second state (a call state) in which the portable terminal 10 is opened will be described by reference to FIGS. 8A to 8C.

As shown in FIG. 8A, the upper housing 11 is opened in the direction of an arrow while the joint section 13 is taken as an axis. As shown in FIG. 8B, the lower end angular section 11A of the upper housing 11 contacts the contact section 35 provided on the antenna section 15, thereby starting to push the antenna section 15 toward the back side 12C of the lower housing 12 as indicated by an arrow.

Since the antenna section 15 is turnably joined to the lower housing 12 by means of the second pin 14 and the auxiliary second pin 29, the antenna section 15 is pushed by the upper housing 11, to thus sway toward the back side 12C of the lower housing 12.

The second pin metal piece 14B is rotated in conjunction with the antenna section 15. Since the rotary shaft 38 does not rotate at this time, the spring member 37 is extended along with rotation of the antenna section 15; namely, rotation of the second pin metal piece 14B.

As shown in FIG. 8C, when the upper housing 11 is opened through a predetermined angle (an open angle β is 165 degrees); namely, to a position of the second state, the antenna section 15 contacts the stopper 36 provided on the lower housing 12, to thus come to a standstill.

The portable terminal 10 is held in the second state (a call state). The antenna section 15 protrudes outward in excess of the back side 12C of the lower housing 12, and in this state the antenna section 15 is held apart from the upper housing 11. Therefore, the antenna section 15 moves away from the upper circuit board 19.

Since the upper circuit board 19 is equal to a ground from a high-frequency viewpoint, electromagnetic coupling arises when the upper circuit board approaches the antenna element 26, which in turn becomes a factor for deteriorating antenna performance.

Accordingly, the antenna element 26 is separated from the upper circuit board 19 when the portable terminal 10 is in the second state, thereby reducing electromagnetic coupling between the antenna element and the upper circuit board and assuring high antenna performance.

Incidentally, the third housing 25 is turnably joined to the lower housing 12 through the second pin 14 and the auxiliary second pin 29.

Thus, when the third housing 25 is of a turnable type, the second pin metal piece 14A and the antenna element 26 become stationary; hence, a stable characteristic is attained.

Moreover, as a result of the portable terminal 10 being held in the second state (the call state), the spring member 37 is held in an extended state. Although the spring member 37 attempts to contract in this state, the spring member 37 is held in an extended state because the upper housing 11 keeps the antenna section 15 in a standstill.

An example first state achieved by closing the portable terminal 10 will now be described by reference to FIGS. 8C and 8A.

The upper housing 11 moves away from the antenna section 15 by closing the upper housing 11 from the state shown in FIG. 8C to the state shown in FIG. 8A.

The second pin metal piece 14B is turned toward the upper housing 11 by spring force of the spring member 37. The antenna section 15 is also turned toward the upper housing 11 in synchronism with the second pin metal piece 14B. The antenna section 15 is fixed to a position where the angle α between the antenna element 26 and the back side 12C of the lower housing 12 is 30 degrees. Specifically, the antenna section 15 automatically returns to a predetermined position (a position shown in FIG. 8A) by spring force of the spring member 37 housed in the second pin 14.

As mentioned above, in the first state of the portable terminal 10, an angle is imparted to the antenna element 26, whereby the third housing 25 is arranged so as to create a step with respect to the outwardly-oriented back side (a rear surface) 12C of the lower housing 12.

Therefore, when the upper housing 11 is placed upside on a desk, or the like, the antenna element 26 becomes apart from the desk, so that high antenna performance can be assured.

The portable terminal 10 can be held thin in the first state by holding the antenna section 15 within the thickness consisting of the upper housing 11 and the lower housing 12.

Moreover, movement of the antenna section 15 is synchronized to opening and closing actions of the portable terminal 10, and hence a user does not need to actuate the antenna section 15.

In addition, the portable terminal 10 is configured so as to bring the upper housing 11 into contact with the third housing 25 and move the third housing 25 by the upper housing 11 when the second state is selected.

As mentioned above, since the upper housing 11 is caused to double as means for moving the third housing 25, the number of members newly prepared for moving the third housing 25 can be reduced, and the structure of the portable terminal 10 can be simplified.

In the first embodiment, a housing hinge is configured so as to join the upper housing and the lower housing together, but the housing hinge may also join the antenna section and the upper housing together. Since the second pin 14 joints the antenna section to the lower housing, the upper housing and the lower housing are joined together through the second pin 14 and the housing hinge in this case.

In the first embodiment, the structure using the spring member 37 is described as means for automatically moving the position of the antenna position 15 in synchronism with closing action of the upper housing 11. However, the means is not restricted to the structure. For instance, a structure embodied by combination of a cam and a gear with a spring member may also be adopted, so long as the structure allows movement of the position of the antenna section 15.

Moreover, in the first embodiment, it is preferable to use a material made of rubber as a material for the contact section 35 that the upper housing 11 contacts. Since the upper housing 11 frequently contacts the contact section 35, the surface of the antenna section 15 can be protected from flaws by making the contact section of a rubber material.

The first embodiment describes an example in which the third housing 25 is supported by two second pins; namely, the second pin 14 and the auxiliary second pin 29. However, the present invention is not limited to the example. The third housing 25 can also be supported by one second pin.

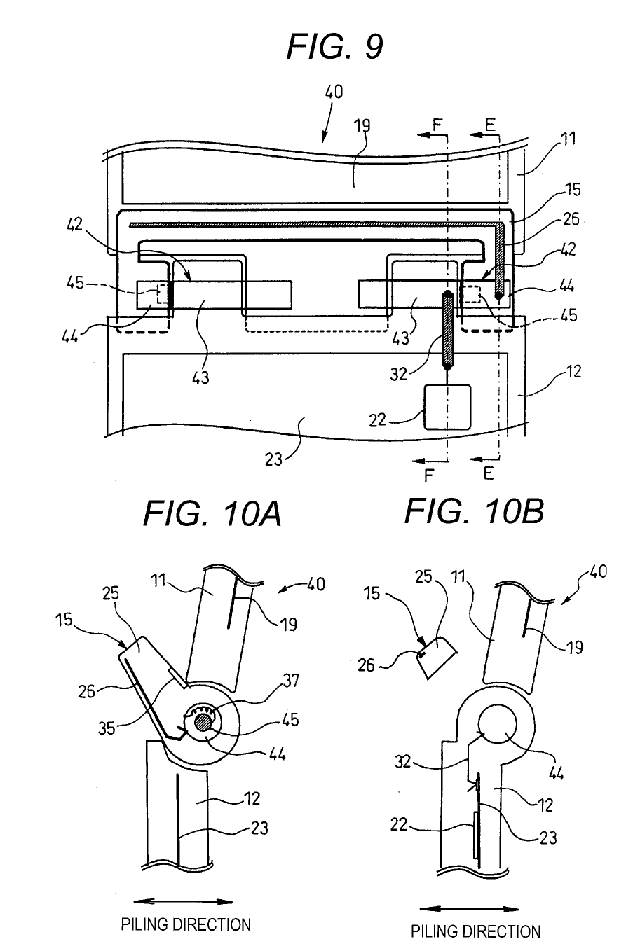

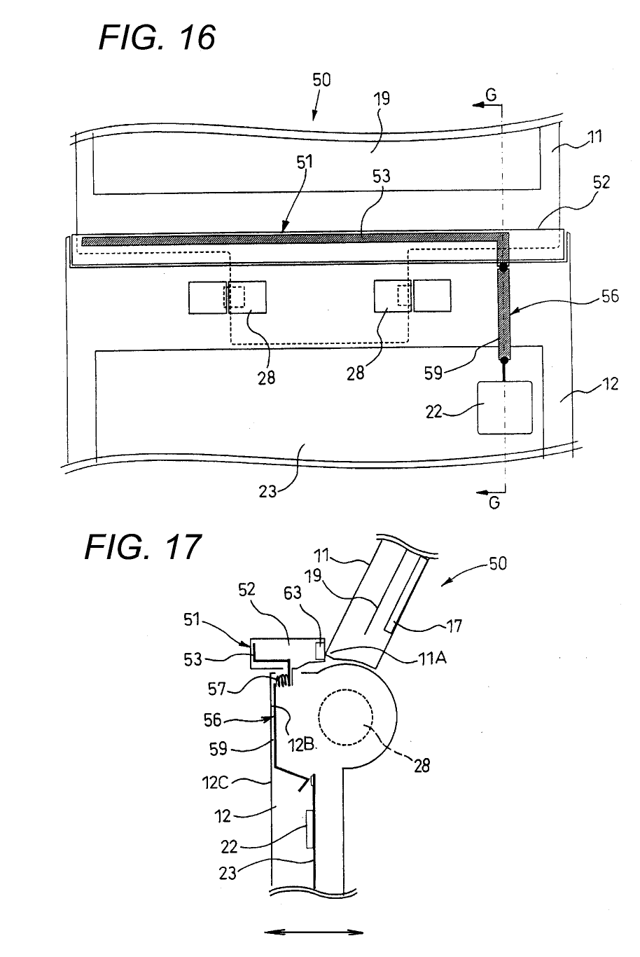

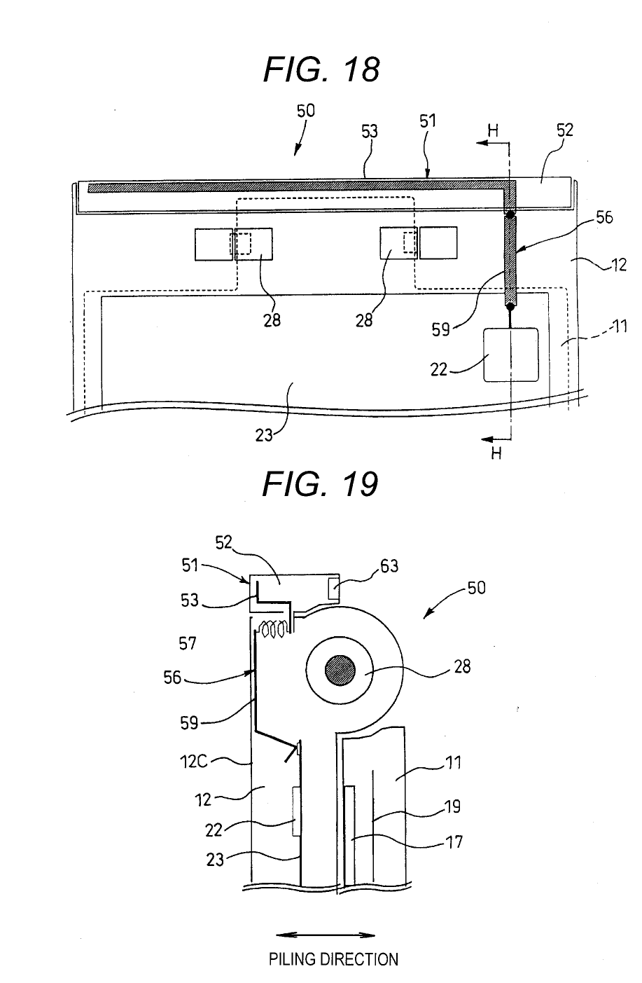

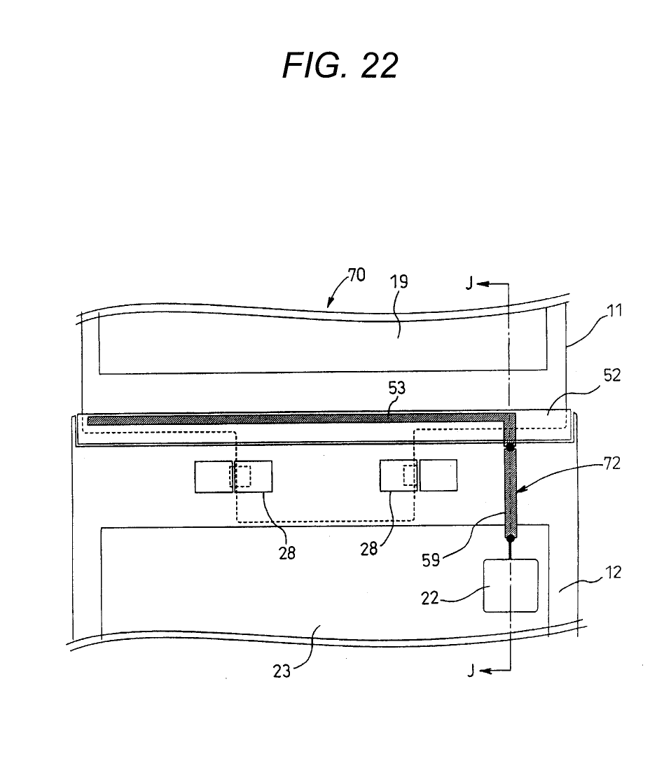

Second through fourth embodiments and first through eighth modifications of the portable terminal will now be described by reference to FIGS. 9 through 27. In the second through fourth embodiments and the first through eighth modifications, members analogous to those of the portable terminal 10 described in connection with the first embodiment are assigned the same reference numerals, and their explanations are omitted.

### Second Embodiment

A portable terminal 40 of a second embodiment shown in FIGS. 9, 10A and 10B has a pair of first pins 42 used for joining the upper housing 11 and the lower housing 12 together and joining the antenna member 15 to the lower housing 12, and is structurally equal to its counterpart of the first embodiment in other respects.

The pair of first pins 42 are arranged so as to be orthogonal to a direction in which the upper housing 11 folds up the lower housing 12, in a first state of the portable terminal 40, and the third housing 25 of the antenna section 15 is joined to the lower housing 12.

Of the pair of first pin 42, the one first pin 42 is made up of a first pin main body 43, a second pin 44, and a rotary shaft 45 for rotatably joining the first pin main body 43 to the second pin 44; and the other first pin 42 is made up of the first pin main body 43, the second pin 44, and the rotary shaft 45 for rotatably joining the first pin main body 43 to the second pin 44.

The first pin 42 and the other first pin 42 are members that are essentially symmetrical with each other.

In the one first pin 42, the first pin main body 43 and the second pin 44 respectively exhibit high electrical conductivity and are electrically connected together.

Further, in the one first pin 42, the rotary shaft 45 and the second pin 44 are connected together by means of the spring member 37. In addition, in the one first pin 42, the antenna element 26 in the antenna section 15 is electrically connected to the second pin 44.

In the other first pin 42, the first pin main body 43 and the second pin 44 are held in an electrically-unconnected state.

Moreover, in the other first pin 42, the antenna element 26 in the antenna section 15 is held in an unconnected to the second pin 44.

The portable terminal 40 of the second embodiment can yield the same advantage as that yielded by the portable terminal 10 of the first embodiment.

In addition, the portable terminal 40 of the second embodiment yields an advantage of the ability to join the upper housing 11 to the lower housing 12 by use of the pair of first pins 42 and join the antenna member 15 to the lower housing 12, thereby making an attempt to reduce the number of components.

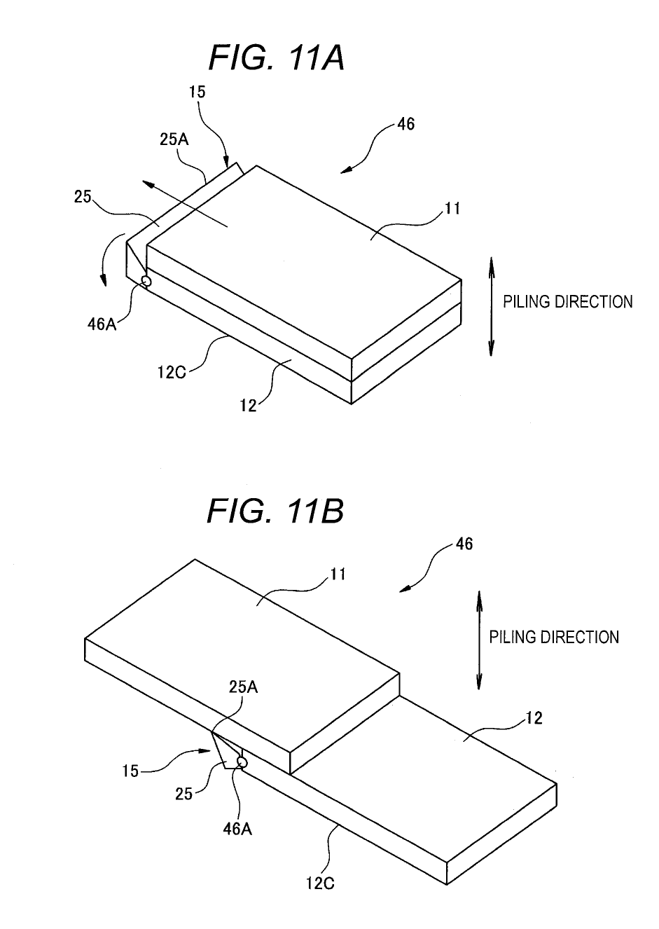

Next, first through fourth modifications of the first and second embodiments will be described by reference to FIGS. 11A through 14B. A portable terminal 46 of the first modification shown in FIGS. 11A and 11B is a slide-type portable terminal that switches between the first state and the second state by sliding the upper housing 11 with respect to the lower housing 12.

The third housing 25 of the antenna section 15 is turnably joined to the lower housing 12 through a second pin 46A as in the first and second embodiments.

As shown in FIG. 11A, in the portable terminal 46, the upper housing 11 contacts a projecting angular section 25A of the third housing 25 as a result of the upper housing 11 being slid in the direction of the arrow, thereby pushing down the projecting angular section 25A toward the back side 12C of the lower housing 12.

As a result, the third housing 25 sways toward the back side 12C of the lower housing 12 while taking the second pin 46A as an axis, as indicated by the arrow.

As a result of the third housing 25 swaying toward the back side 12C of the lower housing 12, the third housing 25 can be placed at a position apart from the upper housing 11 when the portable terminal 46 is in the second state, as shown in FIG. 1l B.

Specifically, as in the first and second embodiments, the portable terminal 46 of the first modification is configured in such a way that the third housing 25 can move in a direction apart from the upper housing 11 as a result of the upper housing 11 contacting the third housing 25 when the upper housing 11 and the lower housing 12 are in the second state.

As a result, the portable terminal 46 of the first modification yields the same advantages as those yielded in the first and second embodiments.

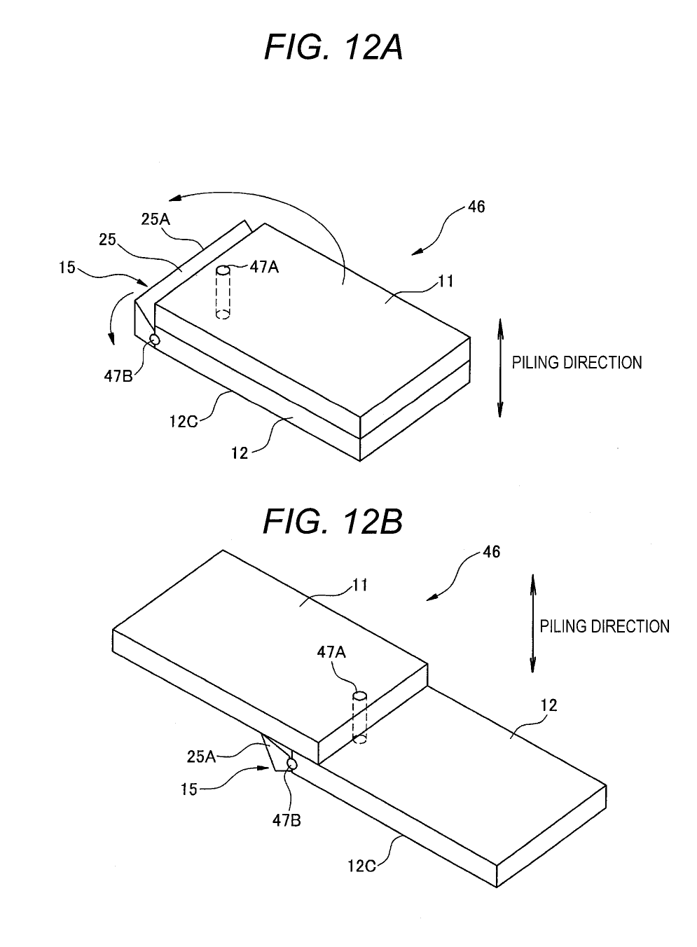

A portable terminal 47 that is a second modification shown in FIGS. 12A and 12B is a rotary portable terminal that switches between the first state and the second state by rotating the upper housing 11 with respect to the lower housing 12 while the first pin 47A is taken as an axis.

The third housing 25 of the antenna section 15 is turnably joined to the lower housing 12 through the second pin 47B as in the first and second embodiments.

As shown in FIG. 12A, in the portable terminal 47, the upper housing 11 is rotated in the direction of an arrow while the first pin 47A is taken as an axis, whereupon the upper housing 11 contacts the protruding angular section 25A of the third housing 25, thereby pushing down the protruding angular section 25A toward the back side 12C of the lower housing 12.

As a result, the third housing 25 sways toward the back side 12C of the lower housing 12 while taking the second pin 47B as an axis, as indicated by the arrow.

As a result of the third housing 25 swaying toward the back side 12C of the lower housing 12, the third housing 25 can be placed at a position apart from the upper housing 11 when the portable terminal 47 is in the second state, as shown in FIG. 12B.

Specifically, the portable terminal 47 of the second modification is configured, as in the first and second embodiments, such that, when the upper housing 11 and the lower housing 12 are in the second state, the upper housing 11 contacts the third housing 25, thereby enabling the third housing 25 to move in a direction away from the upper housing 11.

The portable terminal 47 of the second modification thereby yields the same advantage as that yielded in the first and second embodiments.

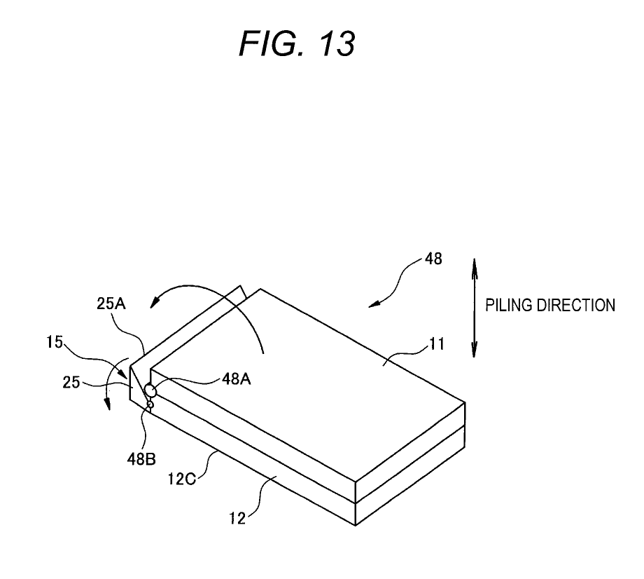

A portable terminal 48 of a third modification shown in FIG. 13 is a clamshell portable terminal in which the upper housing 11 can fold over the lower housing 12 while taking the first pin 48A as an axis and in which the third housing 25 of the antenna section 15 is turnably joined to the lower housing 12 through a second pin 48B.

A first pin 48A and the second pin 48B are separate members, and the first pin 48A and the second pin 48B are arranged in parallel to each other.

In the portable terminal 48, the upper housing 11 is opened to the second state in the direction of an arrow while the first pin 48A is taken as an axis, whereupon the upper housing 11 contacts the protruding angular section 25A of the third housing 25, thereby pushing down the protruding angular section 25A toward the back side 12C of the lower housing 12.

The third housing 25 thereby sways toward the back side 12C of the lower housing 12 as indicated by the arrow while taking the second pin 48B as an axis.

As a result of the third housing 25 swaying toward the back side 12C of the lower housing 12, the third housing 25 can be placed at a position away from the upper housing 11 when the portable terminal 47 is in the second state.

Specifically, the portable terminal 48 of the third modification is configured, as in the first and second embodiments, such that, when the upper housing 11 and the lower housing 12 are in the second state, the third housing 25 can move in a direction away from the upper housing 11 as a result of the upper housing 11 contacting the third housing 25.

The portable terminal 48 of the third modification thereby yields the advantage similar to those yielded by the first and second embodiments.

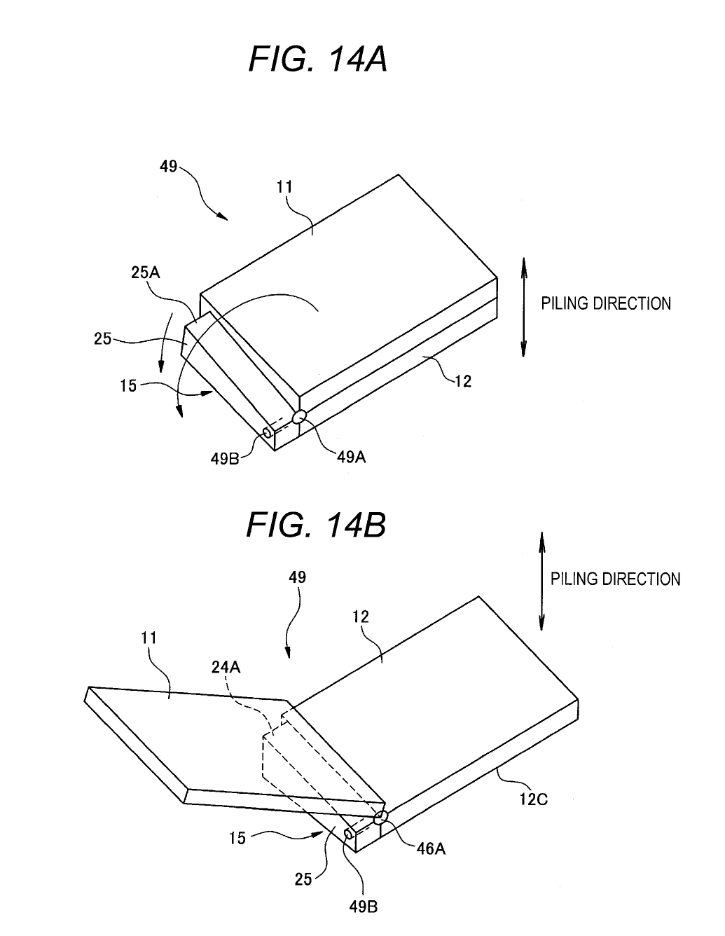

A portable terminal 49 of a fourth modification shown in FIGS. 14A and 14B is a clamshell portable terminal in which the upper housing 11 can fold over the lower housing 12 by taking a first pin 49A as an axis and in which the third housing 25 of the antenna section 15 is turnably joined to the lower housing 12 through a second pin 49B.

The third housing 25 of the antenna section 15 is turnably joined to the lower housing 12 through the second pin 49B. The second pin 49B is a pin arranged so as to face a direction orthogonal to the first pin 49A.

In the portable terminal 49, the upper housing 11 is turned in the direction of an arrow while the first pin 49A is taken as an axis as shown in FIG. 14A, whereby the upper housing 11 contacts the protruding angular section 25A of the third housing 25, to thus push down the protruding angular section 25A toward the back side 12C of the lower housing 12.

The third housing 25 thereby sways toward the back side 12C of the lower housing 12 while taking the second pin 49B as an axis, as indicated by the arrow.

As a result of the third housing 25 swaying toward the back side 12C of the lower housing 12 as shown in FIG. 14B, the third housing 25 can be placed at a position away from the upper housing 11 when the portable terminal 49 is in the second state.

Specifically, the portable terminal 49 of the fourth modification is configured, as in the first and second embodiments, such that, when the upper housing 11 and the lower housing 12 are in the second state, the third housing 25 can move in a direction away from the upper housing 11 as a result of the upper housing 11 contacting the third housing 25.

The portable terminal 49 of the fourth modification thereby yields an advantage analogous to those yielded in the first and second embodiments.

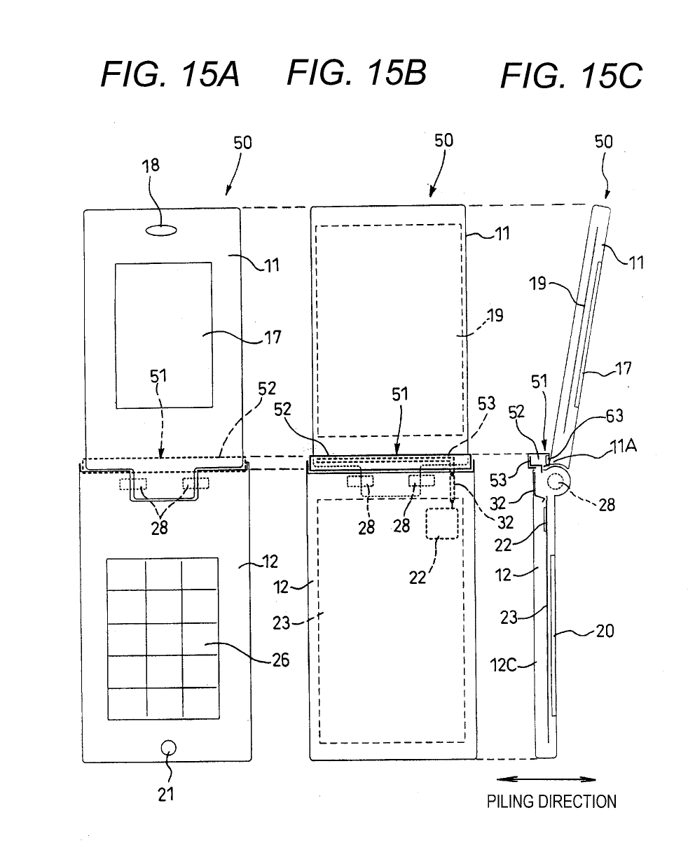

Portable terminals of third and fourth embodiments will now be described by reference to FIGS. 15A through 23.

### Third Embodiment

A portable terminal 50 of a third embodiment shown in FIGS. 15A through 19 has a third housing 52 of an antenna section 51 joined to the lower housing 12 so as to be able to perform translation and is structurally identical, in other respects, with its counterpart described in connection with the first embodiment.

The antenna section 51 has the third housing 52, an antenna element 53 affixed to an interior wall of the third housing 52, and a contact section 63 provided on the third housing 52.

The contact section 63 is preferably made of rubber. Since the lower end angular section 11A of the upper housing 11 frequently contacts the contact section 63, the surface of the third housing 52 can be protected by forming the contact section 63 from rubber.

The upper housing 11 and the lower housing 12 are turnably joined by a pair of first pins 54, and the portable terminal 50 can assume both the form achieved in the second state and the form achieved in the first state by turning the upper housing 11 and the lower housing 12 around the coaxially-arranged first pins 54.

The portable terminal 50 has a connector 56 for electrically connecting the lower housing 12 to the third housing 52 and is configured such that the connector 56 can follow movement of the third housing 52 with respect to the lower housing 12.

The connector 56 has a return spring (an elastic member) 57 that returns the third housing 52 to an initial position with respect to the lower housing 12 in the first state and a feeding element 59 that is electrically connected to the return spring 57 and connected to the communication section (a matching circuit) 22.

The return spring 57 can exhibit electrical conductivity by use of a coil spring made from metal.

A leaf spring can also be used in place of the coil spring made from metal.

The third housing 52 is a box-shaped resin case provided at a position on the lower housing 12 close to the first shaft 28.

The antenna element 53 is affixed to an interior wall of the third housing 52. The antenna element 53 and the feeding element 59 affixed to the lower housing 12 are electrically connected together by means of the return spring 57 exhibiting electrical conductivity.

One end of the feeding element 59 is electrically connected to the communication section (the matching circuit) 22. The antenna element 53 is thus connected to the communication section 22 through the return spring 57 and the feeding element 59.

A contact section 61 that the upper housing 11 contacts when in the second state is provided on an upper end 52A of the third housing 52.

Operation of the antenna section 51 responsive to opening and closing actions of the portable terminal 50 will now be described by reference to FIGS. 19 and 17.

The portable terminal 50 shown in FIG. 19 is closed in the first state. The third housing 52 of the antenna section 51 is placed in the lower housing 12 and held in a state in which the third housing does not protrude in a thicknesswise direction.

In FIG. 19, the third housing 52 of the antenna section 51 is positioned, through example, so as to become flush with the back side 12C of the lower housing 12.

In this state, the return spring 57 that connects the antenna element 53 to the feeding element 59 is held in a state in which the spring does not expand or contract.

In this state, the upper housing 11 and the lower housing 12 are brought into the second state as shown in FIG. 17, whereby the lower end angular section 11A of the upper housing 11 presses the contact section 63 of the antenna section 51.

The upper housing 11 pushes the third housing 52 toward the back side 12C of the lower housing 12, and the third housing 52 protrudes outside from the back side 12C of the lower housing 12.

In association with movement of the third housing 52, the return spring 57 is compressed between an interior wall 12B of the lower housing 12 and the antenna element 53.

When the portable terminal 50 is in the second state, the third housing 52 is held in a state of protruding outside from the back side 12C of the lower housing 12.

Thereby, the antenna element 53 moves away from the upper housing 11, and electromagnetic coupling between the antenna element and the upper circuit board 19 is diminished, whereby high antenna performance is attained.

The contracted return spring 57 undergoes spring force for returning the third housing 52 to its normal position. However, since the upper housing 11 is held in the second state, the return spring 57 is held in a contracted state.

As shown in FIG. 19, as a result of the upper housing 11 being closed in this state, the upper housing 11 moves away from the third housing 52.

The third housing 52 is moved toward the upper housing 11 by means of the spring force of the return spring 57, to thus be pushed back to the inside of the lower housing 12.

Specifically, when the upper housing 11 is closed, the antenna section 51 is automatically placed in the lower housing 12, whereby the portable terminal can be made compact and easy to carry.

Moreover, movement of the antenna section 51, which would be performed in the open and closed states, is carried out in synchronism with opening and closing actions of the portable terminal 50; hence, the user does not separately operate the antenna section 51.

In addition, the portable terminal 50 is configured in such a way that, when the portable terminal is in the second state, the upper housing 11 is brought into contact with the third housing 52, thereby moving the third housing 52 by means of the upper housing 11.

Thus, the upper housing 11 is caused to double as means for moving the third housing 52, whereby the number of components newly prepared for moving the third housing 52 can be reduced, and the structure of the portable terminal 50 can be simplified.

As mentioned above, the portable terminal 50 of the third embodiment can yield an advantage similar to that yielded by the portable terminal 10 of the first embodiment.

In addition, in the portable terminal 50 of the third embodiment, the third housing 52 is of a slide type that performs sliding action, and hence the second pin 14 for feeding purpose can be obviated. Accordingly, the configuration of the antenna feeding section is simple, and a characteristic superior to that achieved by the portable terminals of turnable type described in connection with the first and second embodiments can be maintained.

### Fourth Embodiment

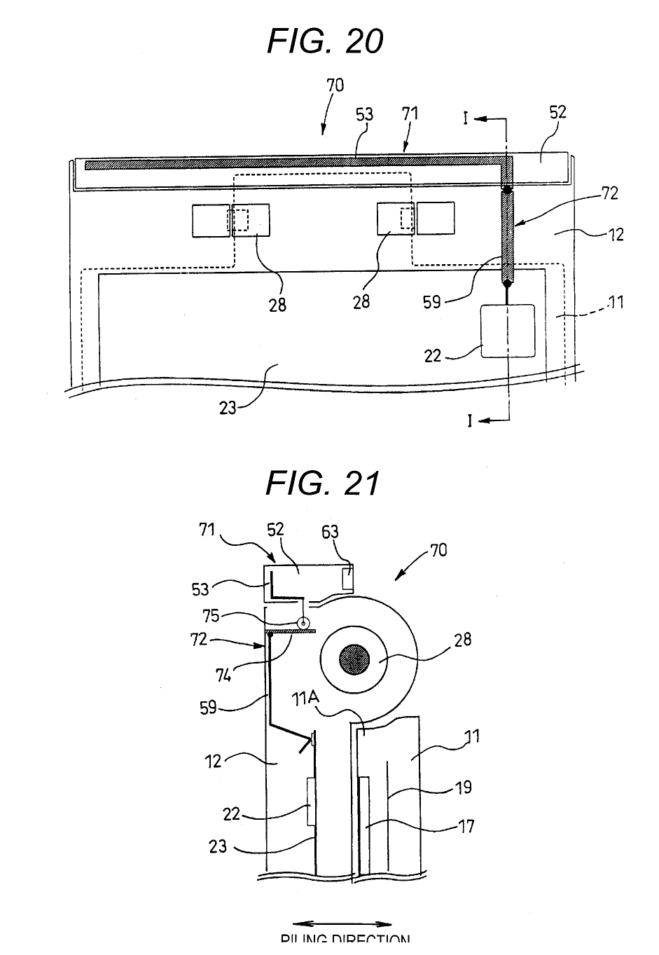

A portable terminal 70 of a fourth embodiment shown in FIGS. 20 to 23 has a conductive rail 74 with a connector 72 of an antenna section 71 provided in the lower housing 12 and a conductive roller (a conductive rolling member) 75 that rolls over the conductive rail 74; and is structurally identical with its counterpart of the first embodiment in other respects.

The conductive roller 75 is connected to an extremity of the antenna element 53.

In the meantime, the conductive rail 74 is connected to an extremity of the feeding element 59. The conductive roller 75 and the conductive rail 74 remain in contact with each other at all times, and power is fed from the communication section (the matching circuit) 22 to the antenna element 53 through the conductive rail 74 and the conductive roller 75.

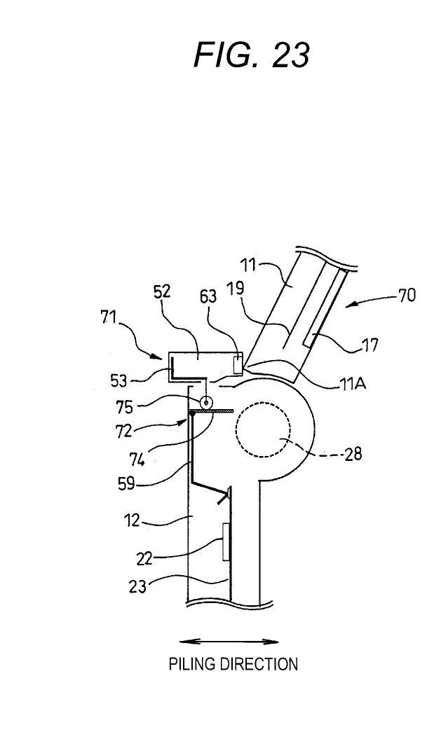

Even when the antenna section 71 is moved by opening and closing actions of the portable terminal 70 performed in a closed state of the portable terminal 70 shown in FIG. 21 and an open state of the portable terminal 70 shown in FIG. 23, the conductive roller 75 moves over the conductive rail 74, whereby the conductive rail and the conductive roller are held in contact with each other at all times, and stable feeding is achieved.

When the portable terminal 70 is opened in the second state, the third housing 52 of the antenna section 71 is pushed by the lower end angular section 11A of the upper housing 11, to thus perform translating action and automatically move.

The portable terminal 70 of the fourth embodiment does not have a return spring, such as that shown in FIGS. 17 and 19.

Therefore, when the portable terminal 70 is closed in the first state, the third housing 52 must be manually returned to its original position.

In order to automatically return the third housing 52 to its original position even when the upper housing 11 is closed, the essential requirement is to provide the interior wall 12B of the lower housing 12 with a return spring as in the third embodiment.

Another requirement is to bring the conductive roller 75 into contact with the return spring when the upper housing 11 is opened, to thus cause the return spring to contract; and to press the conductive roller 75 by means of spring force of the return spring when the upper housing 11 is closed, to thus return the third housing 52 to its original position.

As described above, the portable terminal 70 of the fourth embodiment can yield an advantage similar to that yielded by the portable terminal 50 of the third embodiment.

Moreover, the slide-rail-type portable terminal of the fourth embodiment can enhance durability than does a spring member and flexible wiring.

The fourth embodiment has described the case where the lower housing 12 is provided with the conductive rail 74 and the conductive roller 75. However, the present invention is not limited to the case, and the third housing 52 can also be provided with the conductive rail 74.

In the fourth embodiment, the conductive roller 75 is formed into a circular shape, but the conductive roller yields the same advantage even when formed into a semicircular shape.

Moreover, the feeding element 59 and the antenna element 53 can be electrically connected together by use of flexible wiring or a slider in place of the conductive rail 74 and the conductive roller 75 of the connector 72.

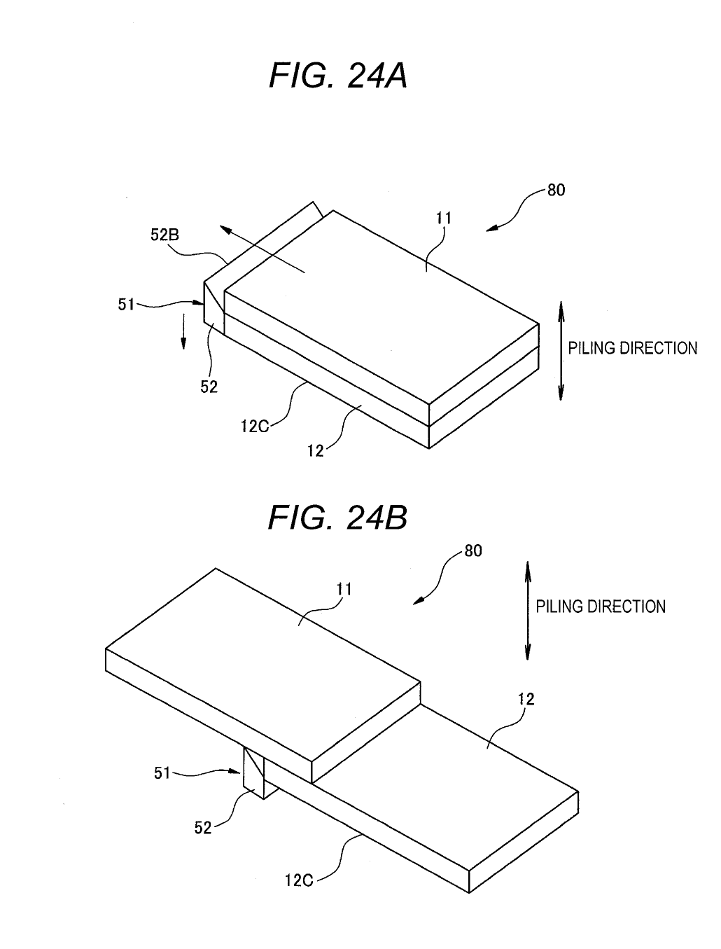

Fifth to eight modifications of the third and fourth embodiments will now be described by reference to FIGS. 24A to 27.

A portable terminal 80 of a fifth modification shown in FIGS. 24A and 24B is a slide-type portable terminal that switches between a first state and a second state by sliding the upper housing 11 with respect to the lower housing 12.

The third housing 52 of the antenna section 51 is joined to the lower housing 12 so as to be slidable as in the third and fourth embodiments.

As shown in FIG. 24A, in the portable terminal 80, the upper housing 11 is slid in the direction of an arrow, whereby the upper housing 11 contacts the protruding angular section 52B of the third housing 52, thereby pushing down the protruding angular section 52B toward the back side 12C of the lower housing 12.

The third housing 52 thereby translates with respect to the lower housing 12 as indicated by an arrow. As a result of the third housing 52 translating toward the back side 12C of the lower housing 12, the third housing 52 can be placed at a position away from the upper housing 11 when the portable terminal 80 is in the second state, as shown in FIG. 24B.

In the portable terminal 80 of the fifth modification, when the upper housing 11 and the lower housing 12 are in the second state, the upper housing 11 contacts the third housing 52 as in the third and fourth embodiments, so that the third housing 52 can move in a direction away from the upper housing 11.

The portable terminal 80 of the fifth modification can thereby yield an advantage similar to those yielded in the third and fourth embodiments.

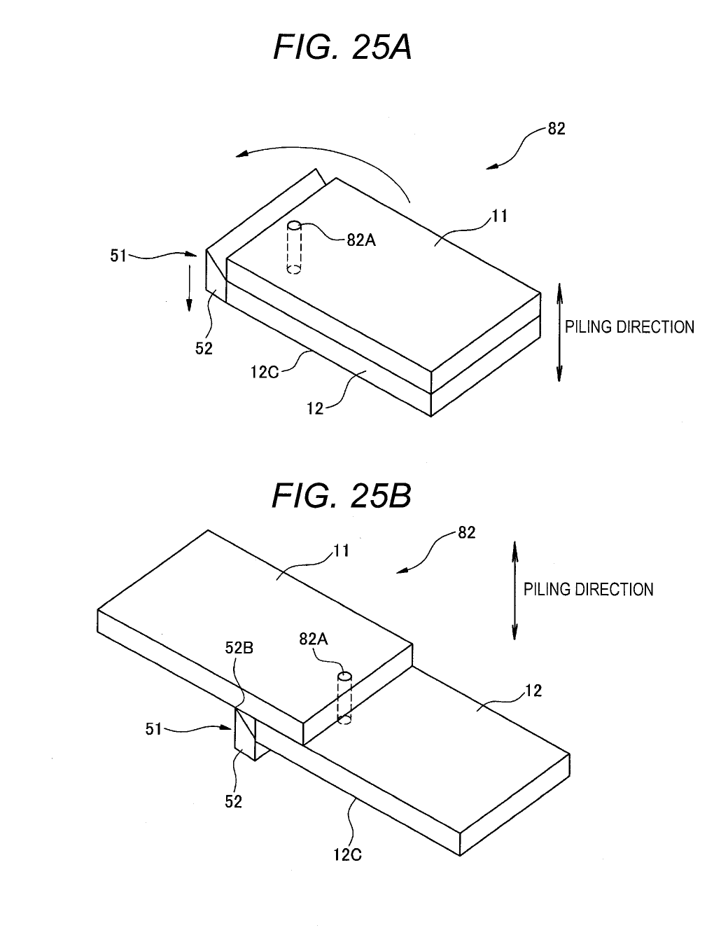

A portable terminal 82 of a sixth modification shown in FIGS. 25A and 25B is a rotary-type portable terminal that switches between the first state and the second state by rotating the upper housing 11 with respect to the lower housing 12 while taking a first pin 82A as an axis.

The third housing 52 of the antenna section 51 is joined to the lower housing 12 so as to be slidable as in the third and fourth embodiments.

As shown in FIG. 25A, in the portable terminal 82, the upper housing 11 is rotated in a direction of an arrow while the first pin 82A is taken as an axis, whereby the upper housing 11 contacts the protruding angular section 52B of the third housing 52, thereby pushing down the protruding angular section 52B toward the back side 12C of the lower housing 12.

As a result, the third housing 52 translates with respect to the lower housing 12 as indicated by an arrow. As a result of the third housing 52 translating toward the back side 12C of the lower housing 12, the third housing 52 can be placed at a location away from the upper housing 11 when the portable terminal 82 is in the second state, as shown in FIG. 25B.

Specifically, the portable terminal 82 of the sixth modification is configured, as in the third and fourth embodiments, such that, when the upper housing 11 and the lower housing 12 are in the second state, the upper housing 11 contacts the third housing 52, so that the third housing 52 can move in a direction away from the upper housing 11.

The portable terminal 82 of the sixth modification thereby yields an advantage similar to those yielded in the third and fourth embodiments.

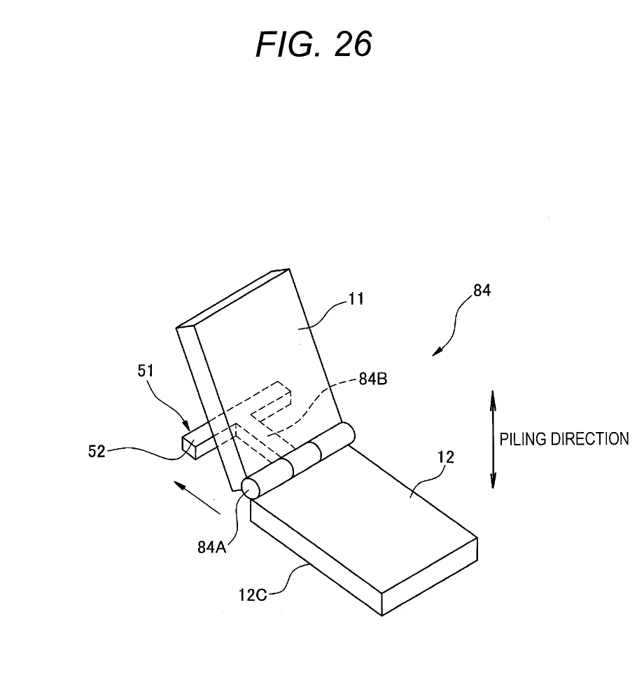

In a portable terminal 84 of a seventh modification shown in FIG. 26, the upper housing 11 can fold over the lower housing 12 while taking a first pin 84A as an axis, and the third housing 52 of the antenna section 51 is joined to the lower housing 12 so as to be slidable (in a direction of an arrow) through a slide section 84B.

In the portable terminal 84, the upper housing 11 is opened to the second state while the first pin 84A is taken as an axis, and the upper housing 11 contacts the third housing 52, thereby pushing the third housing 52 in a direction of an arrow.

When the portable terminal 84 is in the second state, the third housing 52 can be moved in parallel to a location apart from the upper housing 11.

Specifically, the portable terminal 84 of the seventh modification is configured, as in the third and fourth embodiments, such that, when the upper housing 11 and the lower housing 12 are in the second state, the upper housing 11 contacts the third housing 52, so that the third housing 52 can move in a direction away from the upper housing 11.

The portable terminal 84 of the seventh modification thereby yields an advantage similar to those yielded in the third and fourth embodiments.

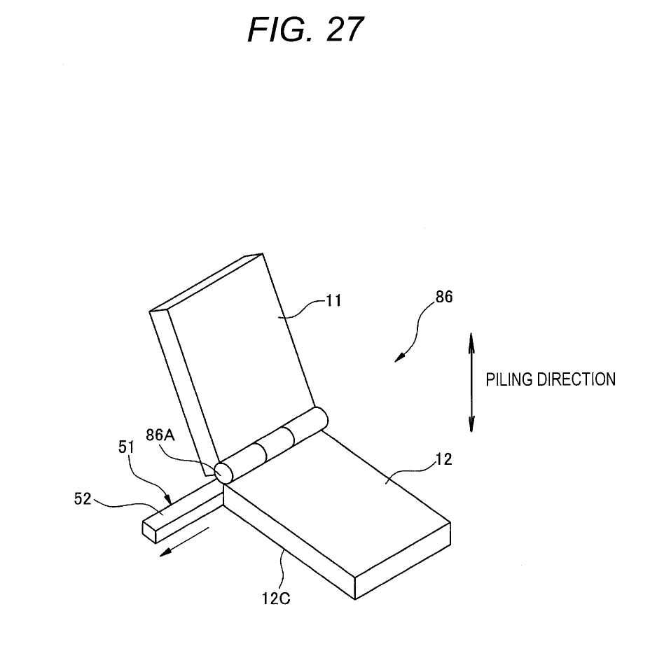

In a portable terminal 86 of an eighth modification shown in FIG. 27, the upper housing 11 can fold over the lower housing 12 while taking a first pin 86A as an axis, and the third housing 52 of the antenna section 51 is joined to the lower housing 12 so as to be slidable (in a direction of an arrow).

In the portable terminal 86, the upper housing 11 is opened to the second state while the first pin 86A is taken as an axis, the upper housing 11 contacts the third housing 52, thereby pushing the third housing 52 in the direction of the arrow. When the portable terminal 86 is in the second state, the third housing 52 can thereby translate over the third housing 52 to a position away from the upper housing 11.

Specifically, the portable terminal 86 of the eighth modification is configured, as in the third and fourth embodiments, such that, when the upper housing 11 and the lower housing 12 are in the second state, the upper housing 11 contacts the third housing 52, so that the third housing 52 can move in a direction away from the upper housing 11.

The portable terminal 86 of the eighth modification thereby yields an advantage similar to those yielded in the third and fourth embodiments.

Although the first through fourth embodiments exemplify the upper housing 11 made of a resin, an upper housing made of metal can also be used.

When the upper housing 11 made of a resin is used, it is important to separate the antenna element away from the upper circuit board (a metal ground). However, in the case of a metal upper housing, it becomes important to separate the antenna element away from the upper housing.

Shapes and configurations of the upper housing 11, the lower housing 12, the joint section 13, the second pins 14 and 44, the antenna sections 15, 51, and 71, the upper circuit board 19, the communication section 22, the third housings 25 and 52, the antenna elements 26 and 53, the first pins 28 and 42, the connector 56 and 72, the return spring 57, the conductive rail 74, and the conductive roller 75, all of which are exemplified in the embodiments, are not limited to those mentioned above and can be changed as necessary.

### INDUSTRIAL APPLICABILITY

The present invention is suitable for being applied to a portable terminal that has an antenna connected to a communication section and that has a first state and a second state by moving a first housing and a second housing.

1. A portable terminal comprising:
a first housing;
a second housing joined to the first housing through a joint section, a first state in which the first housing and the second housing are piled one on top of the other and a second state in which the first housing and the second housing are separated from each other being achieved by relatively moving the first housing and the second housing through the joint section; and
a third housing that is joined to the second housing and that houses an antenna, wherein
the first housing contacts the third housing in the second state, whereby the third housing moves in a direction away from the first housing.

2. The portable terminal according to claim 1, wherein the third housing is turnably joined to the second housing.

3. The portable terminal according to claim 2, wherein the joint section has a first pin orthogonal to a direction in which the first housing and the second housing in the first state are piled one on top of the other;
the third housing is joined to the second housing through a second pin; and
the first pin and the second pin are parallel to each other.

4. The portable terminal according to claim 3, wherein the first pin and the second pin are arranged in line with each other.

5. The portable terminal according to claim 2, wherein the joint section has a first pin orthogonal to a direction in which the first housing and the second housing in the first state are piled one on top of the other; and
the third housing is joined to the second housing through the first pin.

6. The portable terminal according to claim 1, wherein the third housing is joined to the second housing so as to be slidable.

7. The portable terminal according to claim 6, further comprising:
a connector for electrically connecting the second housing to the antenna, wherein
the connector follows movement of the third housing with respect to the second housing.

8. The portable terminal according to claim 7, wherein the connector has an elastic member that exhibits conductivity.

9. The portable terminal according to claim 7, wherein the connector has a conductive rail provided on either the second housing or the third housing and a conductive rolling member that rolls over the conductive rail.

10. The portable terminal according to claim 1, further comprising:
a return spring that restores the third housing to a initial position thereof in the first state with respect to the second housing.

11. A portable terminal comprising:
a first housing;
a second housing joined to the first housing through a joint section, a first state in which the first housing and the second housing are piled one on top of the other and a second state in which the first housing and the second housing are separated from each other being achieved by relatively moving the first housing and the second housing through the joint section; and
a third housing that is joined to the second housing and that houses an antenna, wherein
the third housing is movable with respect to the second housing and arranged so as to form a step with regard to an outwardly-facing back side of the second housing.

12. A portable terminal comprising:
a first housing;
a second housing joined to the first housing through a joint section, a first state in which the first housing and the second housing are piled one on top of the other and a second state in which the first housing and the second housing are separated from each other being achieved by relatively moving the first housing and the second housing through the joint section; and
a third housing that is joined to the second housing and that houses an antenna, wherein
the third housing is movable with respect to the second housing, and a relative position of the third housing with regard to the second housing is restricted.
